(19) United States
(12) Patent Application Publication
(10) Pub. No.: US 2026/0285643 A1
(43) Pub. Date: Sep. 24, 2026

(54) DEVICE AND METHOD FOR INSTALLING AND ADJUSTING PRESSURE OF ROLLER GUIDE, AND ELEVATOR SYSTEM

(71) Applicant: Otis Elevator Company, Farmington, CT (US)

(72) Inventor: Bing Li, Shanghai (CN)

(21) Appl. No.: 19/406,242

(22) Filed: Dec. 2, 2025

(30) Foreign Application Priority Data
Mar. 24, 2025 (CN) 202510352105.1

(51) Int. Cl. B66B 5/00; B66B 7/04

(52) U.S. Cl. CPC B66B 5/0087; B66B 7/047

(57) ABSTRACT

A device and method for installing and adjusting pressure of a roller guide shoe, and an elevator system. The device includes: a bracket, installed on a car frame upright of an elevator car; a positioning portion, installed on the bracket and operatively having a first state in which the positioning portion fixes a positioning of the car frame upright relative to an elevator guide rail to define a reference for installing the roller guide shoe to the car frame upright, and a second state in which the positioning portion releases the positioning; and a pressure adjusting portion, including a contact member installed on the bracket, and a mating member installed at a preset position on the elevator guide rail and located outside a running trajectory of the roller guide shoe on the elevator guide rail.

### FOREIGN PRIORITY

This application claims priority to Chinese Patent Application No. 202510352105.1, filed Mar. 24, 2025, and all the benefits accruing therefrom under 35 U.S.C. § 119, the contents of which in its entirety are herein incorporated by reference.

### TECHNICAL FIELD OF INVENTION

The present disclosure relates to the technical field of elevators, and in particular, to a device and method for installing and adjusting pressure of a roller guide shoe, and an elevator system.

### BACKGROUND OF THE INVENTION

Elevators have been widely installed and used as essential infrastructure in high-rise buildings, transportation hubs (such as stations, airport terminals), residential villas, and private clubs to ensure people's daily travel. This type of elevator equipment generally uses roller guide shoe technologies. When the elevator car goes up and down along the guide rail, the roller guide shoe forms rolling friction with the guide rail through the rollers. Compared with traditional sliding friction mechanisms, it can reduce operational resistance and enhance equipment stability.

Roller guide shoes are generally installed in pairs on the car frame uprights of the elevator car, usually with one roller guide shoe installed at the upper position and another at the lower position of each car frame upright. During the assembly of roller guide shoes, installation position calibration will be performed on these roller guide shoes to ensure accurate positioning and final fixation to the designed installation positions. In some elevator equipment, when the elevator car is in a stationary state, the rollers in the roller guide shoes will maintain contact pressure against the surfaces of elevator guide rail.

### SUMMARY OF THE INVENTION

In view of the foregoing, the present disclosure provides a device and method for installing and adjusting pressure of a roller guide shoe, and an elevator system, so as to solve or at least alleviate one or more of the above problems existing in the prior art and problems in other aspects, or to provide alternative technical solutions for the prior art.

Firstly, according to one aspect of the present disclosure, a device for installing and adjusting pressure of a roller guide shoe is provided, which comprises: a bracket, installed on a car frame upright of an elevator car; a positioning portion, installed on the bracket and operatively having a first state in which the positioning portion fixes a positioning of the car frame upright relative to an elevator guide rail to define a reference for installing the roller guide shoe to the car frame upright, and a second state in which the positioning portion releases the positioning; and a pressure adjusting portion, comprising a contact member installed on the bracket, and a mating member installed at a preset position on the elevator guide rail and located outside a running trajectory of the roller guide shoe on the elevator guide rail, wherein when the elevator car is driven to run close to the preset position and stops, the contact member comes into pressure contact with the mating member to at least reduce a contact pressure between the roller guide shoe and the elevator guide rail.

In a device for installing and adjusting pressure of a roller guide shoe according to the present disclosure, optionally, the positioning portion is detachably installed on the bracket, and the positioning portion is configured to be movable relative to the bracket to switch between the first state and the second state.

In a device for installing and adjusting pressure of a roller guide shoe according to the present disclosure, optionally, the positioning portion comprises: a first member, configured to be movable in a first direction relative to the bracket, to press against or come out of contact with a first side surface of the elevator guide rail; a second member, configured to be movable in the first direction relative to the bracket, to press against or come out of contact with a second side surface of the elevator guide rail, the second side surface being opposite to the first side surface; and a third member, configured to be movable in a second direction relative to the bracket, to press against or come out of contact with an outer end surface of the elevator guide rail, the second direction being perpendicular to the first direction and a vertical direction of an elevator hoistway; wherein, when the positioning portion is in the first state, the first member, the second member, and the third member are respectively pressed against the first side surface, the second side surface, and the outer end surface.

In a device for installing and adjusting pressure of a roller guide shoe according to the present disclosure, optionally, the bracket has a first protrusion portion and a second protrusion portion which protrude outward from a body of the bracket and are arranged at intervals and define a first channel suitable for the elevator guide rail to pass therethrough, and the first member and the second member are respectively provided on the first protrusion portion and the second protrusion portion.

In a device for installing and adjusting pressure of a roller guide shoe according to the present disclosure, optionally, the first protrusion portion and the second protrusion portion are both configured to be parallel to the elevator guide rail, and the first member and the second member are arranged in a same horizontal plane.

In a device for installing and adjusting pressure of a roller guide shoe according to the present disclosure, optionally, the first member, the second member, and the third member are all configured as adjustable bolts.

In a device for installing and adjusting pressure of a roller guide shoe according to the present disclosure, optionally, the bracket is detachably installed on the car frame upright, and the bracket is adjacent to an installation position of the roller guide shoe on the car frame upright.

In a device for installing and adjusting pressure of a roller guide shoe according to the present disclosure, optionally, the bracket has a first extension portion and a second extension portion which extend from a body of the bracket along a length direction of the car frame upright and are arranged at intervals and define a second channel suitable for the elevator guide rail to pass therethrough, and the contact member is installed on the first extension portion or the second extension portion.

In a device for installing and adjusting pressure of a roller guide shoe according to the present disclosure, optionally, the contact member is configured to have a first gap without contact with the elevator guide rail, and/or after the contact member comes into pressure contact with the mating member, at least one roller in the roller guide shoe comes out of contact from the elevator guide rail and a second gap is formed therebetween.

In a device for installing and adjusting pressure of a roller guide shoe according to the present disclosure, optionally, a range of the first gap is 1-10 mm, and the second gap is not less than 1 mm.

In a device for installing and adjusting pressure of a roller guide shoe according to the present disclosure, optionally, the mating member is provided with different sections and forces of different magnitudes are generated accordingly when the contact member is in contact with the different sections, and/or the contact member comprises a rolling element.

In a device for installing and adjusting pressure of a roller guide shoe according to the present disclosure, optionally, the mating member has a first section and a second section, the first section is connected to the second section and arranged along a length direction of the elevator guide rail and has a gradually increasing cross-section towards the second section, a surface of the second section is parallel to a surface of the elevator guide rail, and when the elevator car runs close to the preset position and stops, the contact member is in pressure contact with the surface of the second section.

In a device for installing and adjusting pressure of a roller guide shoe according to the present disclosure, optionally, the preset position is configured at a first distance from a top of an elevator hoistway or a second distance from a bottom of the elevator hoistway, and both the first distance and the second distance are not less than 1 m.

In a device for installing and adjusting pressure of a roller guide shoe according to the present disclosure, optionally, the elevator car runs close to the preset position and stops when an elevator system is in a preset state, the preset state including an idle state and a stopped state.

In addition, according to another aspect of the present disclosure, an elevator system is also provided, which comprises: one or more elevator cars, configured to run within an elevator hoistway; and the device for installing and adjusting pressure of a roller guide shoe according to any one of the above.

In the elevator system according to the present disclosure, optionally, each roller guide shoe on the elevator car is configured with one device for installing and adjusting pressure of a roller guide shoe.

In addition, according to another aspect of the present disclosure, a method for installing and adjusting pressure of a roller guide shoe is further provided, which comprises steps of: installing the device for installing and adjusting pressure of a roller guide shoe according to any one of the above in an elevator system; operating the positioning portion to enter the first state to fix a positioning of a car frame upright of an elevator car relative to the elevator guide rail; installing the roller guide shoe to the car frame upright based on the positioning, and then operating the positioning portion to enter the second state to release the positioning; and causing the contact member to come into pressure contact with the mating member, when the elevator car is driven to run close to a preset position at which the mating member is installed on the elevator guide rail and stops, to at least reduce a contact pressure between the roller guide shoe and the elevator guide rail.

In the method for installing and adjusting pressure of a roller guide shoe according to the present disclosure, optionally, causing at least one roller in the roller guide shoe to come out of contact from the elevator guide rail and forming a gap therebetween by the pressure contact between the contact member and the mating member; and/or generating forces of different magnitudes between the contact member and the mating member by a pressure contact between the contact member and different sections on the mating member, when the elevator car runs close to the preset position and stops; and/or driving the elevator car to run close to the preset position and stop, when the elevator system is in a preset state, the preset state including an idle state and a stopped state.

The solutions of the present disclosure innovatively provide a composite function for installation and positioning, and pressure adjustment of a roller guide shoe. It can not only install a roller guide shoe to an elevator car in an accurate, efficient and convenient manner, achieving a larger contact surface between the roller guide shoe and the elevator guide rail, but also provide effective protection for the roller guide shoe, avoiding or alleviating the deformation or damage of the rollers in the roller guide shoe caused by the pressure between the rollers and the elevator guide rail, especially the static pressure. Thereby, it can reduce the effects of vibration, impact and noise, extend the service life of components, improve the smoothness of elevator operation and enhance passenger comfort. The solutions of the disclosure have strong practicality and are suitable for application to many types of elevator systems, including home lifts and public elevators, with a wide range of application scenarios coverage.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a three-dimensional structural schematic diagram of an example of an elevator system that adopts an embodiment of a device for installing and adjusting pressure of a roller guide shoe according to the present disclosure.

FIG. 2 shows the car frame structure of an example of an elevator car, with an embodiment of a roller guide shoe and an embodiment of a device for installing and adjusting pressure of a roller guide shoe according to the present disclosure installed on two car frame uprights, without showing the mating members in the embodiment of the device.

FIG. 3 is a schematic diagram of the two car frame uprights of the example of an elevator car shown in FIG. 2 contacting and guiding the corresponding example of an elevator guide rail through their respective roller guide shoes.

FIG. 4 is a partial structural schematic diagram of the upper part of the right car frame upright of the example of the elevator car shown in FIG. 2.

FIG. 5 is a three-dimensional structural schematic diagram of the contact members in the bracket, positioning portion, and pressure adjusting portion of the embodiment of the device shown in FIG. 4.

FIGS. 6 and 7 are respectively a partial three-dimensional structural schematic diagram and a top-view structural schematic diagram of the installation of the mating members in the embodiment of the device shown in FIG. 2 to the example of the elevator guide rail.

FIG. 8 is a partial top-view structural schematic diagram of adjusting pressure of an embodiment of a roller guide shoe using the embodiment of the device shown in FIG. 2.

FIG. 9 is a schematic diagram of the processing steps of an embodiment of the method for installing and adjusting pressure of a roller guide shoe according to the present disclosure.

### DETAILED DESCRIPTION OF THE INVENTION

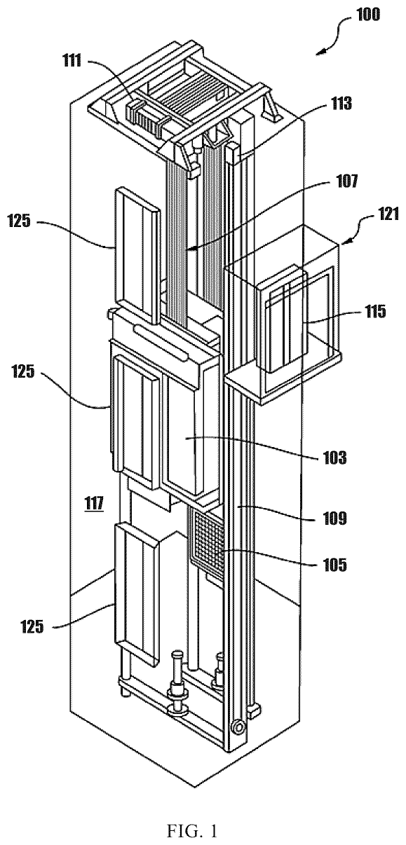

FIG. 1 is a perspective view of an elevator system 100 including an elevator car 103, a counterweight 105, a tension component 107, a guide rail (or rail system) 109, a machine (or machine system) 111, a position reference device 113, and an electronic elevator controller (controller) 115. The elevator car 103 and counterweight 105 are connected to each other by the tension component 107, and travel along the elevator hoistway 117 under the action of driving force. The tension component 107 may include, for example, steel belts (such as coated-steel belts) and/or ropes (such as steel cables). The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension component 107 engages the machine 111. The machine 111 is configured to control movement between the elevator car 103 and the counterweight 105. Machine 111 may include a motor or similar power unit to provide driving force to elevator system 100, which may adopt a machine-room-less configuration. The position reference device 113 may be arranged in other positions and/or configurations known in the art, such as being mounted on a fixed part at the top of the elevator hoistway 117. The position reference device 113 may be configured to provide position signals related to a position of the elevator car and/or counterweight within the elevator hoistway. The position reference device 113 can employ any device or mechanism for monitoring a position of an elevator car and/or counterweight, as known in the art. For example, it includes but is not limited to an encoder, a sensor, or other component, and may include speed sensing, absolute position sensing, and the like.

The controller 115 may be located in a controller room 121 of the elevator hoistway 117 and may be configured to control the operation of the elevator system 100, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference device 113 or any other desired device or system of this kind. When moving up or down within the elevator hoistway 117 along guide rail 109, the elevator car 103 may stop at one or more landings 125 as controlled by the controller 115. Although shown in a controller room 121, those skilled in the art will appreciate that the controller 115 can be located and/or configured in other locations or positions within the elevator system 100, such as located remotely or in the cloud.

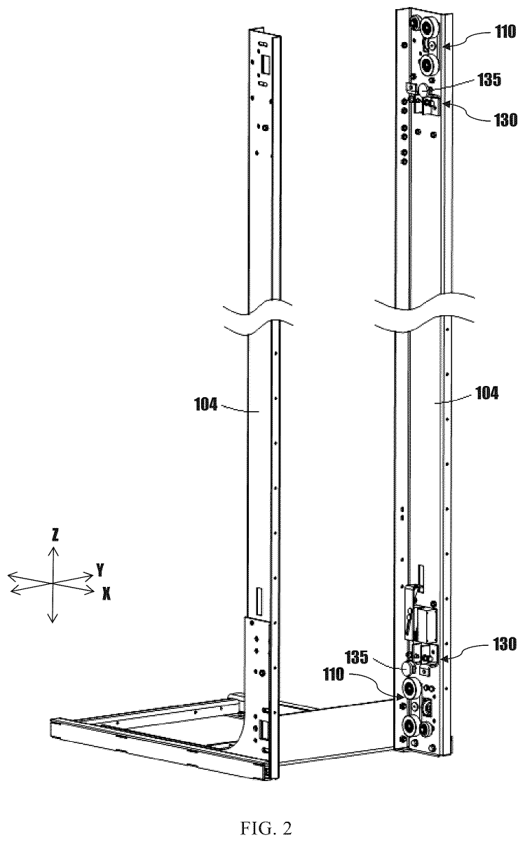

Specific elevator systems and components are shown and described herein. Unless otherwise specified, the components in the example of the elevator system of FIG. 1 can be applied to other embodiments of elevator system according to the present disclosure to achieve the same or similar functions. The present disclosure provides a device with multiple functions for elevator systems, which can be applied to the installation and pressure adjustment, etc. of roller guide shoes, especially suitable for use in environments with relatively small elevator hoistway space dimensions, such as home lifts and other occasions. The device will be described in detail below in conjunction with the specific embodiments illustrated in FIGS. 2 to 8. For the sake of simplification of the drawing, identical or similar components and features may only be denoted in one or several places in the same drawing. Technical terms such as “first”, “second”, “third” are only used for distinguishing purposes and are not intended to indicate their order and relative importance. The technical term “connect” includes both direct and indirect connections.

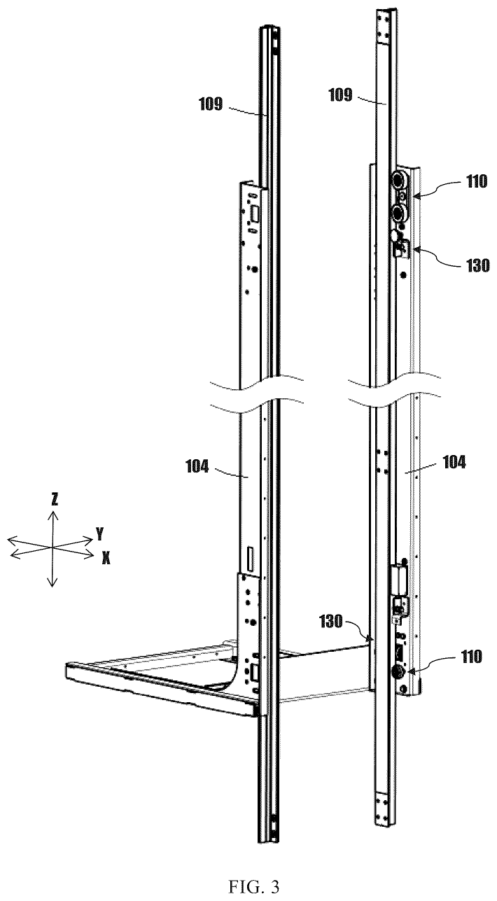

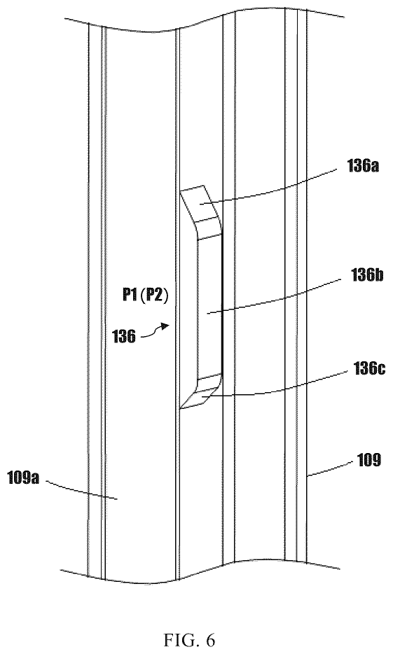

Referring first to FIGS. 2 and 3, these two figures schematically illustrate the general situation of two car frame upright structures of an example of an elevator car contacting and guiding their corresponding examples of elevator guide rail. Roller guide shoes and the embodiment of the device for installing and adjusting pressure of a roller guide shoe according to the present disclosure are installed on these car frame uprights. Although the mating members in the embodiment of the device are not shown in the figures, the general situation of the installation and use of the above-mentioned mating members are shown in FIGS. 6 to 8.

As an example, as used in the embodiments described herein, the elevator car 103 may employ side-mounted car frame uprights 104, where a roller guide shoe 110 can be respectively installed at the upper and lower positions of each car frame upright 104. These two roller guide shoes 110 can be arranged in an inverted configuration relative to each other as shown in FIG. 2, forming a so-called “backpack-type” structure. The elevator with this backpack structure has the advantages of relatively simple configuration, space-saving design, easy installation, and low cost, and it is thus widely used in many occasions such as home lifts and private club elevators. Each roller guide shoe 110 can be configured with a device 130 for installing and adjusting pressure of a roller guide shoe accordingly. For example, the device 130 (excluding the mating members 136) can be arranged adjacent to the roller guide shoe 110, as exemplarily illustrated in FIGS. 2 and 3.

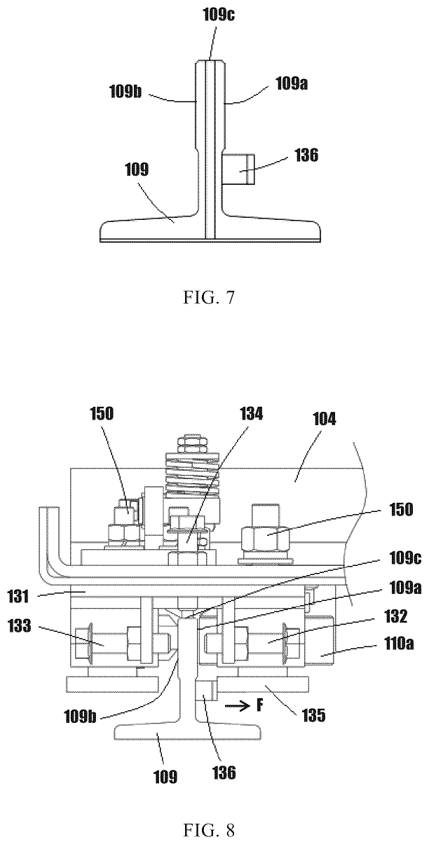

In the illustrated embodiment, the device 130 may comprise a bracket 131, a positioning portion, and a pressure adjusting portion. Specifically, the bracket 131 may be fabricated from rigid materials such as steel or iron, etc. and formed into any suitable shape as needed. The bracket 131 can be installed on the car frame upright 104 of the elevator car 103 using detachable methods (e.g., connecting pieces 150 shown in FIG. 8, such as bolts), welding, and any other feasible methods as needed, so as to provide support for the components in the positioning portions and pressure adjusting portions, for example.

The positioning portion in the device 130 can be installed on the bracket 131 in a detachable manner. Prior to installing the roller guide shoe 110 on the car frame upright 104, the positioning portion can be operated to define the installation reference for assembling the roller guide shoe 110 to the car frame upright 104, for example, to make the car frame upright 104 meet the corresponding requirements in terms of verticality, levelness, etc. for specific applications.

Specifically, the positioning portion can be operated to put it in different states. For example, in the first state (also known as the positioning state), the car frame upright 104 can be fixed and maintained in an expected position relative to the elevator guide rail 109 through the positioning portion. The elevator guide rail 109 have been fixed in place on site using, for example, guide rail brackets, etc., to meet the preset requirements. Accordingly, the relative position between the car frame upright 104 and the elevator guide rail 109 can be fixed through the positioning portion, so that the above positioning can be used to provide the installation reference for the roller guide shoe 110. This makes it very convenient and accurate to install the roller guide shoe 110 on the car frame upright 104. For another example, the positioning portion can be operated to release the above positioning of the car frame upright 104 relative to the elevator guide rail 109, that is, to switch from the first state to the second state (also known as the release positioning state), where the latter is usually the normal state of the positioning portion, that is, when the elevator system is running normally, the positioning portion is in the second state.

It should be appreciated that for the switching operation of the positioning portion between different states, it can be achieved by selecting appropriate relative movement mode between the positioning portion and the car frame upright as needed, such as changing their relative positions by linear movement relative to the car frame upright, or rotation relative to the car frame upright, where the present disclosure does not make any restrictions in this regard. In addition, those skilled in the art can understand that during the process of fixing the elevator guide rail 109 in place on site and adjusting the positioning of the car frame upright 104 relative to the elevator guide rail 109, tools and equipment such as laser level, electronic level, and calibration scale are usually used to ensure compliance in aspects such as verticality and levelness. Therefore, the present disclosure will not discuss them further.

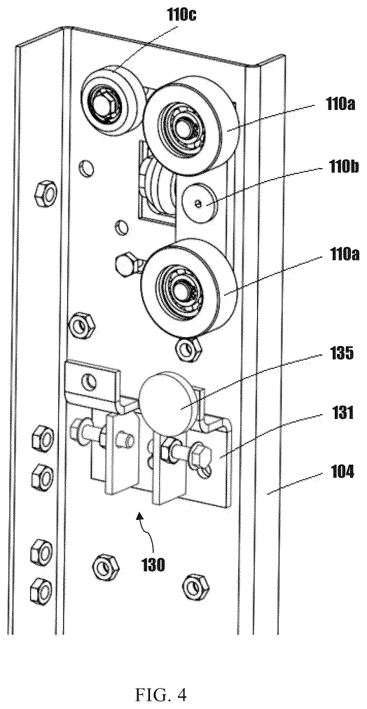

For better understanding, as an illustrative example, referring to, for example, FIGS. 4, 5, 8 and other figures, the positioning portion may be configured to include a first member 132, a second member 133, and a third member 134. Wherein, the first member 132 and the second member 133 can be configured to move relative to the bracket 131 in a first direction X (i.e., the width direction of the vertical car frame upright 104 after installation) as shown in FIGS. 2 and 3, so that the first member 132 can be pressed against or out of contact with a first side surface 109a of the elevator guide rail 109 through corresponding operations, and the second member 133 can be pressed against or out of contact with a second side surface 109b of the elevator guide rail 109 (which is opposite to the first side surface 109a). In addition, the third member 134 can be configured to move relative to the bracket 131 in a second direction Y (which is perpendicular to the first direction X and the vertical direction Z of the elevator hoistway) as shown in FIGS. 2 and 3, so that the third member 134 can be pressed against or out of contact with the outer end surface 109c of the elevator guide rail 109 through corresponding operations.

As described above, by operating the components 132, 133, and 134 as mentioned above, they can be respectively pressed against or out of contact with the first side surface 109a, the second side surface 109b, and the outer end surface 109c. This allows for precise positioning and calibration as well as locking of the positioning of the car frame upright 104 relative to the installed elevator guide rail 109 through several repeated operations. Thus, the relative position of the car frame upright 104 and the elevator guide rail 109 can be accurately adjusted and fixed in three-dimensional space, so that the positioning portion is in the first state, thus providing an accurate installation reference for the installation of the roller guide shoe 110 on the car frame upright 104. Next, the roller guide shoe 110 can be directly assembled to the car frame upright 104 that has been positioned at this point. By performing the reverse operation, the positioning portion can be placed in the second state.

As an example, the first member 132, the second member 133, and the third member 134 can all be configured as adjustable bolts. Such bolt components are not only easy to obtain, but also convenient to operate and maintain, and have low costs. In one or some embodiments, any one or more of the first member 132, the second member 133, and the third member 134 may be constructed with a relatively complex structure. For example, a linkage mechanism may be configured to achieve linkage operations between two or three of them, in order to make the operations easier, more efficient, and accurate.

For the installation of roller guide shoes, the prior art has not considered and provided the device according to the present disclosure. Taking the roller guide shoe shown in FIG. 4 as an example for comparison, in the prior art, when installing the roller guide shoe, it is generally necessary to first install a shaft 110b of the roller guide shoe (usually using an eccentric shaft to adjust the position of the roller guide shoe and the safety gap with the elevator guide rail) into the corresponding mounting hole on the car frame upright, and then adjust the position of the roller guide shoe. During the adjustment, adjustment can only be done in the first direction X shown in FIG. 2, and the adjustment amount is generally only 0-2 mm. In addition, during the process of adjusting the verticality of the car frame upright, the rollers 110a and 110c located on both sides of the elevator guide rail in the roller guide shoe are often in a compressed state, making it difficult to adjust and install. Furthermore, due to the fact that the roller guide shoe is always in a loaded state during adjustment, it is difficult to improve the contact surface between the roller guide shoe and the elevator guide rail to achieve an ideal condition during installation. Therefore, in the case where the contact surface between the roller guide shoe after installation and the elevator guide rail is relatively small, it will affect the quality of elevator car operation and the service life of the roller guide shoe.

The above problems can be successfully solved by using the solution of the present disclosure. As mentioned earlier, by using the device of the present disclosure, the relative position between the car frame upright 104 and the elevator guide rail 109 that has been installed in place on site is first fixed according to application requirements with the help of the positioning portion thereof. This provides an accurate installation reference for the assembly operation of the roller guide shoe 110 to the car frame upright 104. Then, the roller guide shoe 110 can be directly installed and fixed to the installation position on the roller guide shoe 110. The solution of the present disclosure not only simplifies the entire installation process, but also effectively eliminates or reduces assembly errors, better adjusts and achieve the safety gap between the roller guide shoe and the elevator guide rail, and obtains a larger contact surface between the roller guide shoe and the elevator guide rail, which is very conducive to improving the smoothness of elevator operation, reducing the load on the roller guide shoe, and extending its service life. In addition, by using the solution of the present disclosure, ordinary roller guide shoes with non-eccentric shafts can be installed and used on the elevator car, which is also more conducive to adjusting and achieving a relatively larger contact surface between the roller guide shoes and the elevator guide rail, thereby optimizing the load condition of the roller guide shoes.

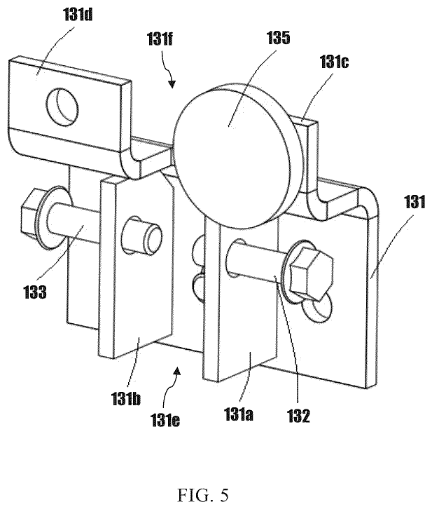

With continued reference to FIGS. 4 and 5, as an optional configuration, the bracket 131 can be constructed with a first protrusion portion 131a and a second protrusion portion 131b for respectively mounting and carrying the first member 132 and the second member 133. The first protrusion portion 131a and the second protrusion portion 131b are configured to protrude outward from the body of the bracket 131, for example, protruding in a direction perpendicular to the body. In addition, these two protrusion portions are spaced apart from each other to form a first channel 131e between them. This channel is provided for the elevator guide rail 109 to pass through, so that when in use, operations such as pressed fixation or release of positioning can be performed on the elevator guide rail 109 from both sides of the elevator guide rail 109 by respectively operating the first member 132 located on the first protrusion portion 131a and the second member 133 located on the second protrusion portion 131b. For the first protrusion portion 131a and the second protrusion portion 131b, they can be integrally formed with the body of the bracket 131 using processes such as casting and machining, or they can be fabricated separately and then fixed to the body of the bracket 131 using connection methods such as welding and screwing. For example, as shown in FIG. 5, the first protrusion portion 131a and the second protrusion portion 131b can be optionally arranged to maintain a parallel relationship. After the device 130 is installed in place on the car frame upright 104, the first protrusion portion 131a and the second protrusion portion 131b can maintain a parallel relationship with the elevator guide rail 109, and the first member 132 and the second member 133 can be placed in the same horizontal plane.

As an optional configuration, the bracket 131 can be constructed with a first extension portion 131c and a second extension portion 131d, which can extend outward from the body of the bracket 131. For example, after the bracket 131 is installed in place, it can extend along the vertical direction Z (i.e., the length direction of the installed elevator guide rail or car frame upright) as shown in FIG. 2, and the first extension portion 131c and the second extension portion 131d are arranged at intervals to form a second channel 131f between them, so that the elevator guide rail 109 can pass through the above channel without causing interference. The contact member 135 later discussed can be installed on the first extension portion 131c or the second extension portion 131d, so that the contact member 135 can be used for coordinated operation with the corresponding mating member 136.

The device 130 is configured with a pressure adjustment portion, which can be used to adjust the contact pressure between the roller guide shoe 110 and the elevator guide rail 109, for example, to reduce or eliminate the influence of static pressure on the roller guide shoe 110 when needed. As an example, as used in the embodiments herein, the pressure adjustment portion may comprise a contact member 135 and a mating member 136, which will be described below.

The contact member 135 can be installed on the bracket 131 using any suitable method, such as detachable connection (e.g., bolts, screws, etc.), welding fixation, etc., for example, fixedly connected to the first extension portion 131c or the second extension portion 131d as discussed above. The contact member 135 can be optionally configured such that when the elevator system is operating normally, the contact member 135 is made not to come into contact with the elevator guide rail 109. This can be achieved by arranging the contact member 135 to maintain a preset gap between it and the elevator guide rail 109, where the specific value of this gap can be set or adjusted as needed. For example, it can be optionally set within the range of 1-10 mm, such as 2 mm, 3 mm, 4 mm, 5 mm, 8 mm, and the like. In addition, in one or some embodiments, it is allowed to arrange the contact member 135 to come into contact with the elevator guide rail 109 during normal operation of the elevator system, thereby playing the role of bearing a portion of the contact pressure and reducing the load on the roller guide shoe 110. According to different application needs, the contact member 135 can be optionally configured with any feasible structural configuration, shape and size, and the like. For example, it can be in the form of one or more rolling elements, etc., or it can be made of one or more materials as needed. For instance, in some applications, rigid materials such as steel and iron can be used alone, and in other applications, elastic or plastic materials can be wrapped around the outside of the structure composed of rigid materials to further bring positive effects such as buffering, noise reduction, and improved smoothness.

The mating member 136 can be installed at a preset position on the elevator guide rail 109 for coordinated use with the corresponding contact member 135. For example, the mating member 136 can be installed at one or several such preset positions using any suitable manner such as detachable connection (e.g., bolts, screws, etc.), welding fixation, and the like. For example, the distance between the preset position P1 (or P2) and the top (or bottom) of the elevator hoistway 117 is not less than a preset value, such as 1 m or any other suitable value. It should be noted that different preset positions can be selected and designed as needed on different car frame uprights 104.

As such, in the case where the application requirements are met, for example, when the elevator system is currently in an idle state (e.g., exceeding a time period that can be set as needed, such as 10 minutes, 20 minutes, or other values), or in a stopped state (e.g., when the elevator system receives a stop instruction from the operator, or enters a pre-set time point, such as 0:00 at midnight to 6:00 am, etc.), the elevator car 103 can run close to the preset position discussed above (e.g., the preset position P1 mentioned above) and stop in such a preset state. At this point, the contact member 135 can be made to contact and press against the corresponding mating member 136 configured, thereby generating a force F between them which is then applied to the contact member 135 (FIG. 8), so that the roller guide shoe 110 (more specifically, one or more rollers 110a in the roller guide shoe 110) that would have been in contact with the elevator guide rail 109 and subjected to pressure can now be out of contact from the elevator guide rail 109, or the contact pressure between the roller guide shoe 110 and the elevator guide rail 109 can be reduced compared to the previous scenario, i.e., at least alleviating the effect of static pressure on the roller guide shoe 110 when the elevator car is in a stopped state. This can protect or alleviate the roller guide shoe 110 from local deformation caused by pressure on the contact surface, which can lead to accelerated wear, noise and vibration and other adverse situations.

According to different application requirements, the mating member 136 and the contact member 135 can be designed and configured accordingly to achieve different pressure adjustment effects on the roller guide shoe 110. For example, differentiated forces F can be generated, for example, these forces have different magnitudes and therefore will bring different influences on the adjustment of the contact pressure borne by the roller guide shoe 110.

For example, the mating member 136 can be configured with different sections, such as two, three, or more sections, so that when the contact member 135 come into contact with these different sections, force F of different magnitudes can be generated between them. For example, the mating member 136 can be optionally configured with two sections, namely a first section and a second section, which can be arranged along the length direction of the elevator guide rail 109. During specific use, if the contact member 135 comes into contact with the first section, a first force will be generated, and if the contact member 135 comes into contact with the second section, a second force will be generated, where the second force can be greater than the first force. As such, as an optional scenario, by designing the magnitude of the first and second forces accordingly, it is possible to control the different contact conditions between the roller guide shoe 110 and the elevator guide rail 109, so as to better achieve different desired effects. For example, under the first force, a relatively small gap can be maintained between the roller guide shoe 110 and the elevator guide rail 109, while under the second force, a relatively large gap can be maintained. Considering that the roller guide shoe 110 may continuously wear out during long-term use, it is very advantageous to adaptively and flexibly adjust and provide the required gap.

As another example, as exemplarily shown in FIG. 6, the mating member 136 can be configured with three sections, with the first section 136a and the third section 136c arranged at both ends of the second section 136b, respectively. The first section 136a can be configured with, for example, a wedge-shaped guide portion, i.e., with a gradually increasing cross-section towards the direction of the second section 136b, so as to guide the contact member 135 and the mating member 136 to come into pressure contact more smoothly. The third section 136c may adopt the same or similar configuration as the first section 136a. In addition, the second section 136b can be configured such that its surface is parallel to the surface of the elevator guide rail 109. In this way, when the elevator car 103 runs close to the preset position of the mating member 136 and finally stops, the contact member 135 can first come into contact with the first section 136a, and then enter a state of stable pressure contact with the second section 136b. At this point, the force F generated by the pressure contact can smoothly and uniformly act on the contact member 135, which is more conducive to maintaining system stability and avoiding deformation or damage of the contact member, etc. due to poor pressure.

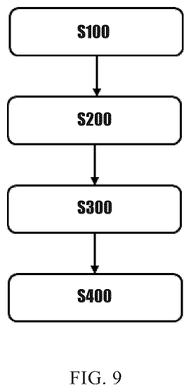

FIG. 9 illustrates the basic steps of the method according to the present disclosure, which can be used for the installation and pressure adjustment of roller guide shoes. Specifically, the embodiment of this method may include the following steps:

In step S100, a device for installing and adjusting pressure of a roller guide shoe provided by the present disclosure can be installed in an elevator system. The composition, operation, and technical advantages of the device of the present disclosure have been discussed in detail in conjunction with specific examples in the previous text, so reference can be made to the above content.

In step S200, the positioning portion of the above device is operated to enter the first state, thereby fixing the positioning of the car frame upright of the elevator car relative to the elevator guide rail, so as to provide an installation reference for assembling the roller guide shoe to the car frame upright.

In step S300, based on the positioning reference already achieved in step S200, the roller guide shoe can be installed on the car frame upright in a very convenient, accurate, and efficient manner. And, after completing the installation operations of the roller guide shoe, reverse operations can be performed on the positioning portion, that is, releasing the positioning of the car frame upright relative to the elevator guide rail previously fixed by operating the positioning portion, so that the positioning portion switches from the first state to the second state.

In step S400, when, for example, the elevator system is in a preset state (such as an idle state, a stopped state, etc., which can be detected or judged by, for example, the controller 115, etc.) and other conditions as required by the application, the elevator car can be driven to run close to the preset position of the mating member in the above device on the elevator guide rail and stop, such that the mating member and the contact member come into pressure contact, thereby forcing the adjustment of the current contact pressure between the roller guide shoe and the elevator guide rail. Accordingly, the contact pressure can be eliminated or reduced.

Those skilled in the art can appreciate that the technical content such as the configuration and composition, installation, and use of the device for installing and adjusting pressure of roller guide shoes, roller guide shoes, and car frame uprights have been described in detail in the previous text. For example, the contact member can be made to come into contact with different sections of the mating member to generate forces of different magnitudes to meet different application needs. For another example, the mating member can be made to come into pressure contact with the contact member to release one or more target rollers desired to be protected in the roller guide shoe from contact with the elevator guide rail, thereby forming a gap between the target roller and the elevator guide rail. Therefore, reference can be directly made to the specific content of the corresponding sections in the previous text, which can form more possible steps and configurations of the method of the present disclosure, and therefore will not be repeated.

A device and method for installing and adjusting pressure of a roller guide shoe, and an elevator system according to the present disclosure have been described above in detail by way of examples. These examples are merely used to illustrate the principles and embodiments of the present disclosure, rather than limiting the present disclosure. Various modifications and improvements can be made by those skilled in the art without departing from the scope of the present disclosure. Therefore, all equivalent technical solutions should fall within the scope of the present disclosure and be limited by the claims of the present disclosure.

What is claimed is:

1. A device for installing and adjusting pressure of a roller guide shoe, comprising:
a bracket, installed on a car frame upright of an elevator car;
a positioning portion, installed on the bracket and operatively having a first state in which the positioning portion fixes a positioning of the car frame upright relative to an elevator guide rail to define a reference for installing the roller guide shoe to the car frame upright, and a second state in which the positioning portion releases the positioning; and
a pressure adjusting portion, comprising a contact member installed on the bracket, and a mating member installed at a preset position on the elevator guide rail and located outside a running trajectory of the roller guide shoe on the elevator guide rail, wherein when the elevator car is driven to run close to the preset position and stops, the contact member comes into pressure contact with the mating member to at least reduce a contact pressure between the roller guide shoe and the elevator guide rail.

2. The device for installing and adjusting pressure of a roller guide shoe according to claim 1, wherein the positioning portion is detachably installed on the bracket, and the positioning portion is configured to be movable relative to the bracket to switch between the first state and the second state.

3. The device for installing and adjusting pressure of a roller guide shoe according claim 2, wherein the positioning portion comprises:
a first member, configured to be movable in a first direction relative to the bracket, to press against or come out of contact with a first side surface of the elevator guide rail;
a second member, configured to be movable in the first direction relative to the bracket, to press against or come out of contact with a second side surface of the elevator guide rail, the second side surface being opposite to the first side surface; and
a third member, configured to be movable in a second direction relative to the bracket, to press against or come out of contact with an outer end surface of the elevator guide rail, the second direction being perpendicular to the first direction and a vertical direction of an elevator hoistway;
wherein, when the positioning portion is in the first state, the first member, the second member, and the third member are respectively pressed against the first side surface, the second side surface, and the outer end surface.

4. The device for installing and adjusting pressure of a roller guide shoe according to claim 3, wherein the bracket has a first protrusion portion and a second protrusion portion which protrude outward from a body of the bracket and are arranged at intervals and define a first channel suitable for the elevator guide rail to pass therethrough, and the first member and the second member are respectively provided on the first protrusion portion and the second protrusion portion.

5. The device for installing and adjusting pressure of a roller guide shoe according to claim 4, wherein the first protrusion portion and the second protrusion portion are both configured to be parallel to the elevator guide rail, and the first member and the second member are arranged in a same horizontal plane.

6. The device for installing and adjusting pressure of a roller guide shoe according to claim 3, wherein the first member, the second member, and the third member are all configured as adjustable bolts.

7. The device for installing and adjusting pressure of a roller guide shoe according to claim 1, wherein the bracket is detachably installed on the car frame upright, and the bracket is adjacent to an installation position of the roller guide shoe on the car frame upright.

8. The device for installing and adjusting pressure of a roller guide shoe according to claim 1, wherein the bracket has a first extension portion and a second extension portion which extend from a body of the bracket along a length direction of the car frame upright and are arranged at intervals and define a second channel suitable for the elevator guide rail to pass therethrough, and the contact member is installed on the first extension portion or the second extension portion.

9. The device for installing and adjusting pressure of a roller guide shoe according to claim 1, wherein the contact member is configured to have a first gap without contact with the elevator guide rail, and/or after the contact member comes into pressure contact with the mating member, at least one roller in the roller guide shoe comes out of contact from the elevator guide rail and a second gap is formed therebetween.

10. The device for installing and adjusting pressure of a roller guide shoe according to claim 9, wherein a range of the first gap is 1-10 mm, and the second gap is not less than 1 mm.

11. The device for installing and adjusting pressure of a roller guide shoe according to claim 1, wherein the mating member is provided with different sections and forces of different magnitudes are generated accordingly when the contact member is in contact with the different sections, and/or the contact member comprises a rolling element.

12. The device for installing and adjusting pressure of a roller guide shoe according to claim 11, wherein the mating member has a first section and a second section, the first section is connected to the second section and arranged along a length direction of the elevator guide rail and has a gradually increasing cross-section towards the second section, a surface of the second section is parallel to a surface of the elevator guide rail, and when the elevator car runs close to the preset position and stops, the contact member is in pressure contact with the surface of the second section.

13. The device for installing and adjusting pressure of a roller guide shoe according to claim 1, wherein the preset position is configured at a first distance from a top of an elevator hoistway or a second distance from a bottom of the elevator hoistway, and both the first distance and the second distance are not less than 1 m.

14. The device for installing and adjusting pressure of a roller guide shoe according to claim 1, wherein the elevator car runs close to the preset position and stops when an elevator system is in a preset state, the preset state including an idle state and a stopped state.

15. An elevator system, comprising:
one or more elevator cars, configured to run within an elevator hoistway; and
the device for installing and adjusting pressure of a roller guide shoe according to claim 1.

16. The elevator system according to claim 15, wherein each roller guide shoe on the elevator car is configured with one device for installing and adjusting pressure of a roller guide shoe.

17. A method for installing and adjusting pressure of a roller guide shoe, comprising steps of:
installing the device for installing and adjusting pressure of a roller guide shoe according to claim 1 in an elevator system;
operating the positioning portion to enter the first state to fix a positioning of a car frame upright of an elevator car relative to the elevator guide rail;
installing the roller guide shoe to the car frame upright based on the positioning, and then operating the positioning portion to enter the second state to release the positioning; and
causing the contact member to come into pressure contact with the mating member, when the elevator car is driven to run close to a preset position at which the mating member is installed on the elevator guide rail and stops, to at least reduce a contact pressure between the roller guide shoe and the elevator guide rail.

18. The method for installing and adjusting pressure of a roller guide shoe according to claim 17, wherein,
causing at least one roller in the roller guide shoe to come out of contact from the elevator guide rail and forming a gap therebetween by the pressure contact between the contact member and the mating member; and/or
generating forces of different magnitudes between the contact member and the mating member by a pressure contact between the contact member and different sections on the mating member, when the elevator car runs close to the preset position and stops; and/or
driving the elevator car to run close to the preset position and stop, when the elevator system is in a preset state, the preset state including an idle state and a stopped state.
